(19) United States
(12) Patent Application Publication
(10) Pub. No.: US 2012/0095675 A1
(43) Pub. Date: Apr. 19, 2012

(54) METHOD FOR CREATING AND TAKING A DRIVING TOUR

(75) Inventors: ALFRED C. TOM, SAN FRANCISCO, CA (US); FRANCES H. JAMES, SUNNYVALE, CA (US); STEVEN C. TENGLER, GROSSE POINTE PARK, MI (US); THOMAS P. GRAU, ROCHESTER, MI (US)

(73) Assignees: GENERAL MOTORS LLC, DETROIT, MI (US); GM GLOBAL TECHNOLOGY OPERATIONS, INC., DETROIT, MI (US)

(21) Appl. No.: 12/905,338

(22) Filed: Oct. 15, 2010

(51) Int. Cl. G01C 21/00

(52) U.S. Cl. 701/425; 701/426

(57) ABSTRACT

Embodiments of methods for creating and taking a driving tour using information derived from crowd sourcing are disclosed herein. A method includes, but is not limited to accessing an Internet website that is configured to enable a user to compose a driving tour based in part on the information derived from crowd sourcing and in part on a user-specified criterion. The method further includes inputting the user-specified criterion into the Internet website. The method further includes creating the driving tour using the Internet website, the driving tour having a point of interest. The method further includes obtaining an electronic file from the Internet website containing the driving tour. The method further includes loading the electronic file into a mobile device. The method still further includes utilizing the mobile device and the electronic file to take the driving tour.

### TECHNICAL FIELD

The technical field generally relates to driving tours, and more particularly relates to systems and methods for creating and taking driving tours.

### BACKGROUND

A common recreational activity is the taking of driving tours of scenic, historically significant or otherwise interesting locations. Frequently, people tour such locations by driving through areas of interest and stopping to explore them. Some people elect to drive themselves on these tours. One drawback to this approach is a person's inability to read a guidebook and simultaneously operate a motor vehicle. Accordingly, persons taking this sort of do-it-yourself tour may drive right past a particular point-of-interest (hereinafter, POI) without learning anything about it. Drivers may also get lost using guidebooks, as paper maps and directions may not help them stay on the route as well as GPS-enabled turn-by-turn navigation systems.

Another option is to take a prepackaged tour where both the driving and POI information are provided by another entity. Several business entities provide such prepackaged guided tours to members of the public in exchange for a fee. These business entities typically provide transportation and a tour guide who is knowledgeable about the area that is the subject of the tour. Although such prepackaged guided tours obviate the need to drive and read a guidebook simultaneously, this approach has drawbacks as well. For example, the prepackaged tour may be expensive, may not start at a convenient time/location, or may include some POIs that are not of interest to the person taking the tour.

In addition, both of these approaches have additional drawbacks. For example, a guidebook may be prepared by a publisher who relies on a relatively small number of sources of information, resulting in a guidebook that includes a correspondingly small number of POIs. Similarly, the prepackaged guided tour is limited by the number of POIs with which the tour guide is personally familiar. Also, some guidebook publishers may charge a fee to POI proprietors to have a POI included in the guidebook. This can result in the omission of interesting POIs whose proprietors are unwilling to pay the fee and/or the inclusion of POIs that are less interesting, but whose proprietors are willing to pay the fee. The same can be true of prepackaged guided tours. In addition, guided tours are typically offered at specific times on specific dates without flexibility of start time, interruptions or permitting spontaneity injected by the customer at or between POIs. Guided tours are also typically offered to large groups, and may not be available or conducive to creating a personalized experience for a family, small group of friends, or an individual.

### SUMMARY

Various methods for creating and taking a driving tour are disclosed herein.

In an embodiment, the method includes, but is not limited to, accessing an Internet website that is configured to enable a user to compose a driving tour based in part on the information derived from crowd sourcing and in part on a user-specified criterion. The method further includes inputting the user-specified criterion into the Internet website. The method further includes creating the driving tour using the Internet website. The driving tour has at least point of interest. The method further includes obtaining an electronic file from the Internet website that contains the driving tour. The method further includes loading the electronic file into a mobile device. The method still further includes utilizing the mobile device and the electronic file to take the driving tour.

In another embodiment, the method includes, but is not limited to, accessing an Internet website that is configured to enable a user to compose a driving tour based in part on the information derived from crowd sourcing and in part on a user-specified criterion. The method further includes inputting the user-specified criterion into the Internet website. The method further includes creating the driving tour using the Internet website. The driving tour has at least one point of interest. The method further includes obtaining an electronic file from the Internet website containing the driving tour. The method further includes loading the electronic file into a mobile device. The method further includes connecting the mobile device to a navigation system associated with a vehicle. The method still further includes utilizing the mobile device, the electronic file, and the navigation system to take the driving tour.

In another embodiment, the method includes, but is not limited to, accessing an Internet website that is configured to enable a user to compose a driving tour based in part on the information derived from crowd sourcing and in part on a user-specified criterion. The method further includes inputting the user-specified criterion into the Internet website. The method further includes creating the driving tour using the Internet website. The driving tour has at least one point of interest. The method further includes obtaining an electronic file from the Internet website containing the driving tour. The method further includes loading the electronic file into a mobile device. The method further includes utilizing the mobile device and the electronic file to take the driving tour. The method still further includes receiving information about the point of interest during the driving tour in a geographically synchronized manner.

### DESCRIPTION OF THE DRAWINGS

One or more embodiments will hereinafter be described in conjunction with the following drawing figures, wherein like numerals denote like elements, and

FIG. 1 is a schematic view illustrating an embodiment of system for producing tours;

FIG. 2 illustrates an exemplary Internet web page designed to receive information from a user that can be used by the system of FIG. 1 for producing a tour;

FIG. 3 illustrates an exemplary Internet web page designed to permit a user to edit a tour produced by the system of FIG. 1;

FIG. 4 illustrates an exemplary Internet web page that provides a user with information about one of the POIs included in the tour produced by the system of FIG. 1;

FIG. 5 illustrates an exemplary Internet web page designed to permit a contributing user to provide feedback regarding a POI;

FIG. 6 is a flow diagram illustrating the steps of a method for producing a tour;

FIG. 7 is a schematic view illustrating an alternate way to access the system of FIG. 1 to produce a tour;

FIG. 8 is a flow diagram illustrating an example of a method for creating and taking a driving tour using information derived from crowd sourcing;

FIG. 9 is a flow diagram illustrating another example of a method for creating and taking a driving tour using information derived from crowd sourcing; and

FIG. 10 is a flow diagram illustrating still another example of a method for creating and taking a driving tour using information derived from crowd sourcing.

### DETAILED DESCRIPTION

The following detailed description is merely exemplary in nature and is not intended to limit application and uses. Furthermore, there is no intention to be bound by any expressed or implied theory presented in the preceding technical field, background, brief summary or the following detailed description.

Various embodiments of systems and methods for producing a tour and various methods for creating and taking a driving tour are disclosed herein. The systems and methods disclosed herein take advantage of the abundant technology currently available to consumers in the form of embedded or in-dash navigation systems, and portable devices having any suitable location determining technology (e.g. Global Positioning System (hereinafter “GPS”)) including, but not limited to, cellular telephones (hereinafter “cell phones”), aftermarket navigation devices, and any other portable devices having location determining capabilities that permit them to determine their location on the surface of the earth. As used herein, the term “mobile device” shall refer to both portable devices and navigation systems that are embedded or otherwise integrated into a vehicle.

The systems and the methods combine the availability of this technology with the existing widespread usage of the Internet by providing remotely accessible network services such as, but not limited to, an Internet accessible website which is configured to enable a user to compose a tour. As used herein, the term “user” refers to any person accessing the website, whether to create a tour, to contribute information, or for any other purpose. The user may access the Internet website using either a computer (e.g., a desk top computer, a lap top computer or a vehicle based computer) or a mobile device. To create the tour, the user need only input a few items of information. Such information may include a destination or a geographical region to be explored, the amount of time that the user would like to spend on the tour, the types of POIs that the user would like to visit, the types of roads on which the user would like to travel and the types of scenery that the user would like to see along the way.

Once this information has been input into the website, the website is designed to produce a tour that is customized for the user. The tour may include one or more POIs and potentially one or more prepackaged routes that correspond to the user's inputs. For example, if the user inputs only a single criterion specifying historical POIs, then the tour will include only POIs having historical significance.

Additionally, the POIs and/or routes may be arranged in a sequence that conforms with the user's expressed preferences or that otherwise makes logical sense (e.g., shortest distance, chronological history, etc . . . ). This sequence can ultimately be used to create a navigation route for the tour that leads the user past the selected POIs and along any selected prepackaged routes. For example, if the user expressed a desire to limit the tour to a predetermined number of miles, then the POIs and/or routes will be arranged in a sequence that keeps the total distance traveled equal to or under the predetermined number of miles. In another example, if the user has expressed a desire to travel along scenic roads, then the POIs in the tour may be arranged in a sequence that ensures that the user will travel along scenic roads, or the tour may include a prepackaged route that was designed specifically to travel along scenic roads.

In some embodiments of the system, when the tour includes multiple POIs or routes, the user will have an opportunity to edit the tour by selecting or deleting one or more of the suggested POIs or routes. The user may also be able to add additional POIs and/or routes to the tour. For example, the website may be configured to allow the user to browse through POIs and/or routes located proximate to the tour route and to select one or more of these for inclusion on the tour.

The user may then download the tour to their mobile device or may download the tour to their personal computer and then transfer the tour to their mobile device. The mobile device (if a portable device) can then be connected with the user's automobile through an auxiliary jack, a USB port, a Bluetooth connection, or via another suitable connection and may be used to guide the user as the user drives to and through the POIs and along the routes. The mobile device (if a portable device) may play audio and/or video commentary about the POI through the vehicle's onboard systems, such as a vehicle's stereo system, its DVD entertainment system, its embedded navigation system, its telematics system, or through any other suitable system onboard the vehicle. In other embodiments, the mobile device may play back such commentary to the user without the aid of any onboard audiovisual system. In some instances, a user may be able to download the tour directly to a telematics unit located in the user's automobile. In this last instance when the mobile device is embedded in the vehicle as the case of a telematics unit, then a separate portable device is not necessary.

The tour, once loaded onto the mobile device, may be capable of interacting with the mobile device's position determining capability (e.g., GPS chipset, Wi-Fi, cellular base stations, etc . . . ) to automatically play and/or render portions of the tour relating to the geographic region that the user is presently driving through or approaching. In other embodiments, the mobile device may lack position determining capability, but may nevertheless obtain current location information through a connection with another onboard position determining system to obtain position coordinates and to trigger the playback and/or rendering of relevant portions of the tour.

The website may further be configured to receive POI inputs and/or prepackaged routes from users. As used herein, the term “POI input” means any information pertaining to a POI including an identification of the POI, an electronic file containing an audible, pictoral or video commentary about a POI, a textual description relating to a POI, music or interpretive content relating to the POI, or a rating or ranking of the POI. “Prepackaged route” means information pertaining to a set of waypoints and turn-by-turn instructions to follow that will lead a user along one or more roads. Prepackaged routes may also contain POI inputs as described above. The term “prepackaged route” may be used herein interchangeably with the term “predefined tour”. A POI input also may be an identification of a new POI including its title, its GPS location information (including information on a POI's “geobound” which tells the system when to trigger POI content in a navigation device), its street address, its Internet website address, a ground-level picture, a satellite picture, and a description of the new POI. The website may also be configured to permit users to input entire tours that they have taken, including multiple POIs and the roads that were traveled between them (hereinafter, “predefined tours”). Users who provide POI inputs or predefined tours will be referred to herein as “contributing users”. The website may permit contributing users to designate whether or not other contributing users may edit, append to, or reuse information provided about a POI by the original user, therein improving the collective knowledge past the limited knowledge of the original contributing user. The website may also be configured to allow contributing users to charge for the content they contribute. This is useful not only for professional travel organizations that may contribute their content, but also for amateur users who know an area particularly well and would like to get paid for their expertise. The website may collect revenue from other users on behalf of these contributing users and then pay the contributing users all or a portion of the revenue. Techniques for allowing contributing users to offer paid content, collecting payment from users, and paying the contributing users are commonly understood in the industry. The use of contributing users to identify new POIs, to provide predefined tours, and to provide feedback about existing POIs will result in a continuously expanding database of POIs, POI information, and predefined tours. This method of collecting POI information is referred to as crowd sourcing. By implementing crowd sourcing, the system can tap into a far greater knowledge base than is currently available to publishers of guide books or to business entities that offer tour guide services.

Using this system, a user can access a website over the Internet, choose a geographic region to explore or a start point and an end point, input one or more categories of POI and/or other criteria, and then obtain a custom made tour of the specified geographic region that includes only those POIs that are of interest to the user. The user can then download the tour to a mobile device (e.g. a portable device or a telematics unit embedded and associated with a vehicle) and take the tour at a time of the user's choosing. The user may connect the mobile device (if a portable device) to an entertainment system onboard the user's vehicle and then listen to and watch commentary, reviews, descriptions and other relevant information about each POI included in the tour as the user drives to and through each POI.

A further understanding of the systems and methods for producing a tour described above may be obtained through a review of the illustrations accompanying this application together with a review of the detailed description that follows.

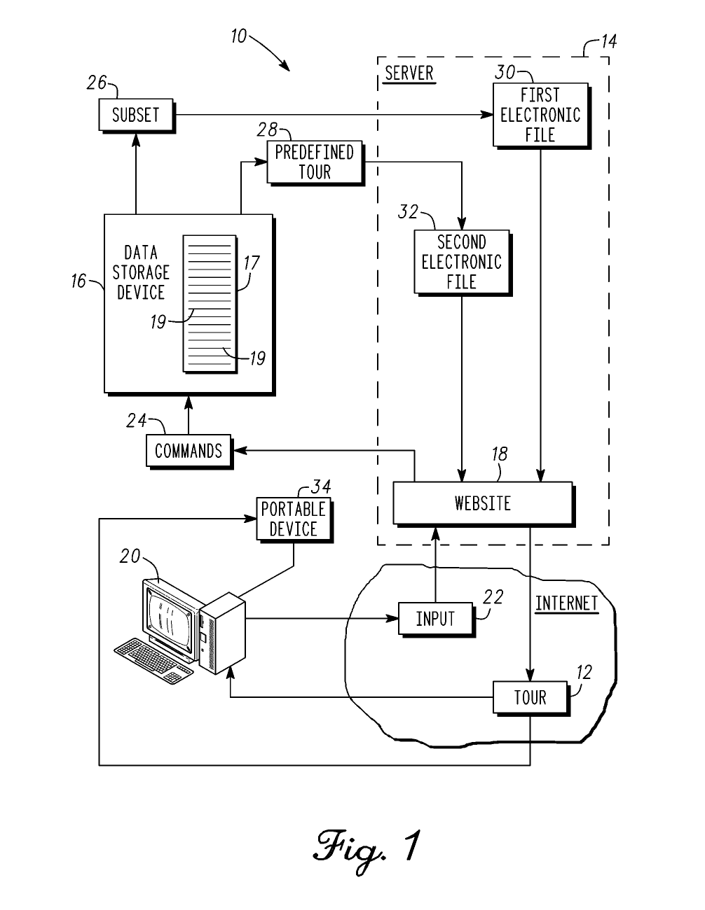

FIG. 1 is a schematic view illustrating a system 10 for producing a tour 12. System 10 includes a server 14 operatively coupled to a data storage device 16. In other embodiments, additional servers, data storage devices, or other components may also be included.

Server 14 may be any combination of hardware or software designed to provide services to clients and/or to manage resources on a computer network. Server 14 may be a personal computer that is running a server operating system or it may be a computer or computer appliance that is specially designed to enhance its ability to run software applications under the heavy demand of a network environment and that contains features making it more suitable for production environments. These features may include a faster CPU, increased high-performance RAM, redundant power supplies, and redundant network connections. In some embodiments, server 14 may be dedicated exclusively to managing data storage device 16. In such embodiments, additional components, such as a processor, may also be included in system 10. In other embodiments, server 14 may be configured to both manage resources such as data storage device 16 and to also run and execute other programs. Server 14 is configured for network connectivity and can be connected to a wide variety of computer networks including Local Area Networks (“LAN”) and Wide Area Networks (“WAN”), such as the Internet.

Data storage device 16 may be any type of electronic memory device that is configured to store data. For example, data storage device 16 may include, without limitation, non-volatile memory, disk drives, tape drives, and mass storage devices and may include any suitable software, algorithms and/or sub-routines that provide the data storage component with the capability to store, organize, and permit retrieval of data. In some embodiments, data storage device 16 may comprise only a single component. In other embodiments, data storage device 16 may comprise a plurality of components acting in concert. In some embodiments, data storage device 16 may be dedicated for use exclusively with system 10 while in other embodiments, data storage device 16 may be shared with other systems. In some embodiments, data storage device 16 may be a separate or stand alone component that can be communicatively coupled with server 14 via any suitable wired or wireless connection, while in other embodiments, data storage device 16 may be a component of server 14 or otherwise integrated into server 14 and internally communicatively coupled therewith. For example, data storage device 16 and server 14 may be a single device (e.g., a server that includes storage memory and that runs database software).

Data storage device 16 is configured to store data relating to users, POIs and predefined tours. Server 14 is configured to provide commands to data storage device 16 that cause data storage device 16 to store the data, to organize the data, and to produce the data to server 14. The data may comprise POIs, POI inputs, predefined tours, user accounts, user names and user passwords which may be required by system 10 before granting a user access to a user account.

Server 14 is also configured to host a website 18. Website 18 is an Internet accessible website that users may access remotely via computer 20. Although computer 20 is illustrated as a desktop computer, it should be understood that computer 20 may be any suitable device capable of accessing the Internet, including, but not limited to, a mainframe computer, a desktop computer, a laptop computer, a smart phone, a personal digital assistant (“PDA”), and an Internet enabled tablet device.

Using computer 20, a user can access website 18 to upload POIs, POI inputs, and predefined tours, or to compose and download a tour. In some embodiments, the user may be required to input their name or some other identification such as an account number, a user ID and/or a password. In such embodiments, the information provided or solicited by the user can be associated with the user's account maintained by system 10 on data storage device 16. In other embodiments, a user may be able to access and utilize website 18 without providing any identification.

The user may then provide or upload one or more inputs 22 to website 18. In the case of a contributing user seeking to upload information, input 22 may include a predefined tour, a POI input, and/or a ranking of an existing predefined tour or POI input. In the case of a user seeking to compose a tour or seeking to retrieve a predefined tour, input 22 may include a criterion or multiple criteria that are needed to compose the tour. For example, input 22 may include the date or time of year when the user intends to travel, the geographic region or destination that the user would like to explore, the types of attractions that the user would like to visit, the distance that the user is willing to travel, the amount of time that the user is willing to devote to taking tour 12, the types of roads and scenery that the user would like to encounter along the way, a minimum rating received by contributing user, and any combination thereof. Server 14 can be configured to present multiple web pages on website 18, each of which can be tailored to a specific purpose and can facilitate the user's ability to upload input 22 to server 14.

Server 14 is programmed or otherwise configured to provide commands 24 to data storage device 16 to either store or retrieve data in response to receiving inputs 22 from a contributing user or a user composing a tour. For example, if input 22 comprises a POI input or a predefined tour, commands 24 will instruct data storage device 16 to store such information and to do so at a specific location. Such information may be maintained on data storage device 16 in a database 17 that can be accessed by server 14. In the illustrated embodiment, system 10 is configured to keep separate user accounts 19 for each user. The information contained in input 22 may be stored on data storage device 16 in a manner such that it is correlated with the user account associated with the contributing user.

If input 22 comprises one or more criterion input by a user composing a tour, then server 14 is configured to search the POIs and other information stored in data storage device 16 and to filter such data to derive a subset 26 of POI inputs that satisfy the criterion or criteria supplied by the user.

If input 22 comprises one or more criterion input by a user seeking to obtain a predefined tour, then server 14 is configured to search the predefined tours and other information stored in data storage device 16 and to filter such data to locate a predefined tour 28 that most closely complies with the user's inputs. In some embodiments, the results of this search may include multiple predefined tours, each substantially equally compliant with the criteria provided in input 22.

In the case of subset 26, the POI inputs may then be stored, either temporarily or permanently, on server 14 in a first electronic file 30. The POI inputs in first electronic file 30 can be arranged and revised in a manner that corresponds with input 22. For example, if subset 26 includes a large number of POI inputs, but the user has indicated that the user has only a relatively short time in which to take the tour, then server 14 may execute various algorithms and protocols to reduce the number of POI inputs in the subset by giving greater or lesser weight to one or more of the criteria included in input 22 or by randomly selecting a POI input for elimination from the subset. Server 14 may also be programmed to arrange the POI inputs in an appropriate sequence. The appropriate sequence of POI inputs in subset 26 may be based on their GPS location, their proximity to major thoroughfares, the types of roads leading to the POIs, the travel time between the POIs, and any other basis that enables tour 12 to better comply with the user's criteria. Server 14 may include a mapping program or may have access to map files stored in data storage device 16 to facilitate the sequencing of the POI inputs. In other embodiments, server 14 may remotely access or otherwise connect to mapping applications to display POIs on maps and to perform route calculations using the POI inputs in subset 26. After such revising and sequencing is complete, the arrangement of POI inputs remaining in first electronic file 30 constitutes tour 12. In some embodiments, the user may be permitted to edit tour 12 by adding or deleting or rearranging the POI inputs included in tour 12.

In the case where there are multiple predefined tours 28 that satisfy the criteria included in input 22, the predefined tours 28 are each stored, either temporarily or permanently, in a second electronic file 32, or in multiple respective second electronic files 32. The number of predefined tours 28 may then be reduced to some predetermined maximum number of predefined tours specified by the user in input 22. The remaining predefined tours 28 may then be arranged in a sequence based on their compliance with the specific criteria included with input 22. After such revising and sequencing is complete, the listing of predefined tours 28 in second electronic file 32 may be presented to the user on a web page of website 18. At that time, the user may be permitted to select one or more of the predefined tours 28. Additionally, the user may be able to combine one or more of the predefined tours 28. In addition, the user can also add additional POIs to predefined tours 28 to further customize them. In some instances, the user may need to purchase content that is not offered for free. The predefined tour(s) 28 selected and/or modified by the user constitutes tour 12.

Both first electronic file 30 and the second electronic file 32 may be stored in an electronic format that is compatible with a portable device of the user's choosing. Website 18 may be configured to permit the user to select an electronic file format from among many different file formats, each compatible with a different type of portable device. Alternatively, the file formats may be in a metadata format that is generic to any device. When the user wants to download to a specific device, there may be a conversion engine that converts the generic file format to a format that is specific to the actual device. Once the user selects the appropriate format, tour 12 may be downloaded. In one embodiment, the user may choose to download tour 12 to computer 20, and then to transfer tour 12 to portable device 34. In other embodiments, if the user is accessing website 18 using portable device 34, then tour 12 may be downloaded directly to portable device 34. In yet another embodiment, the user may instruct the website to download tour 12 to a second portable device 34 separate from the device accessing the website 18. In other embodiments, the website may be configured to permit the user to electronically mail first or second electronic file 30, 32 to an email address of the user's choosing. In still other embodiments, any other method effective to deliver tour 12 to the user may be employed.

When the user takes the tour, they will select the appropriate electronic file containing the tour from their portable device's menu and execute it. Alternatively, the electronic file may be configured to prompt the user to start the tour automatically. The electronic file will be configured to command the portable device to obtain location information (such as GPS location information) from the device's GPS receiver (or other location determining equipment), or from a separate GPS receiver in another portable device or from a separate system of the vehicle. The navigation system of the device will use the information in the electronic file to produce a route that will be used to guide the user in a manner similar to the manner in which a navigation application guides users to a particular destination. In fact, the route can be viewed as directions to multiple destinations one after another, each destination being either a POI or a waypoint along a route chosen by the user. In other embodiments, route guidance may be formulated on server 14 and tour 12 may consist of step-by-step driving instructions as well as POIs and waypoints. The electronic file will be configured to further control the portable device to coordinate the presentation of the POI information included in the tour with the present location of the vehicle or portable device. To accomplish this, the electronic file will include geographically synchronized commands (including audio/visual files or tagged text for activating text-to-speech engines) that will instruct the portable device to play or otherwise activate the presentation of commentary associated with the POI inputs when the portable device approaches to within a predetermined distance of the POI (the “geobound” of the POI). Accordingly, as the portable device approaches a POI, the portable device will detect its proximity to the POI and will automatically begin playback of commentary associated with that POI using either the vehicle's onboard entertainment systems, an in-dash navigation system or a speaker associated with the portable device itself.

In some embodiments, after a predetermined period of time has elapsed since the user downloaded tour 12, server 14 may be configured to follow up with the user to obtain feedback about tour 12. For example, server 14 may be configured to transmit an email to the user with a link to a website (e.g., website 18) where the user can answer questions about their tour. In other embodiments, any other method of communication suitable for soliciting user feedback may be employed. In some embodiments, the tour may permit instantaneous feedback during the tour while the experience is still fresh. Non-limiting examples of feedback might be structured rating systems (e.g., 5-star, like/dislike, thumbs up/down), commentary (e.g. social networking thoughts/experiences during tour), and/or pictures taken with embedded or portable technology during the tour.

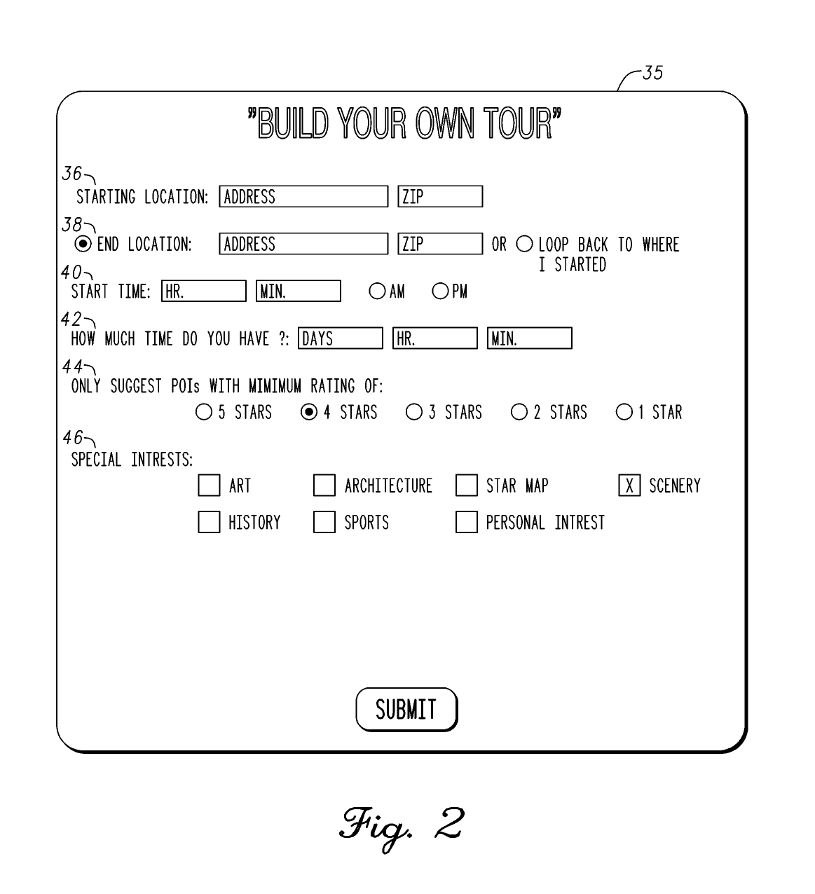

FIG. 2 illustrates an exemplary Internet web page 35 that may be displayed on computer 20 and that is designed to receive information from a user that can be used by the system of FIG. 1 for producing a tour. In the embodiment illustrated in FIG. 2, and with continuing reference to FIG. 1, the user is asked to provide a starting address 36 and an ending address 38. In lieu of providing an ending address, the user may simply indicate a desire to return to the starting address. The use of a starting address and an ending address may be useful in situations where the user needs to travel from one location to another and would like to have an interesting drive rather than simply taking the most direct route. The situation where the user indicates an intent to end at the same address where the user began may be more appropriate for situations where the user wants to become familiar with a particular geographic region.

The user is also asked to enter the start time 40 and the amount of time 42 the user can devote to taking the tour. This information can be used by server 14 to factor in meals that will be consumed during the tour, and to choose POIs having operating hours that are compatible with the user's schedule (thus implying that in some embodiments POIs may also be defined by operating hours).

The user is also asked to specify a minimum rating 44 to be used by server 14 when selecting POIs or predefined tours from data storage device 16. Minimum rating 44 is a rating associated with each POI that has been provided by contributing users to rate a POI or a predefined tour that has been uploaded to server 14. Any suitable method of rating a POI or predefined tour may be employed.

The user is also asked to identify any special interests 46 that the user would like featured in tour 12. As indicated, the user may specify an interest in art, architecture, star maps (i.e., a tour identifying the location of celebrities), scenery, historical locations, sports themed locations, and personal interests, among other things. POIs and predefined tours may have such identifying tags associated with them to enable this search feature. By selecting personal interests, the user may be redirected to a new web page where the user may have an opportunity to enter any specific interest that is not expressly enumerated on web page 35.

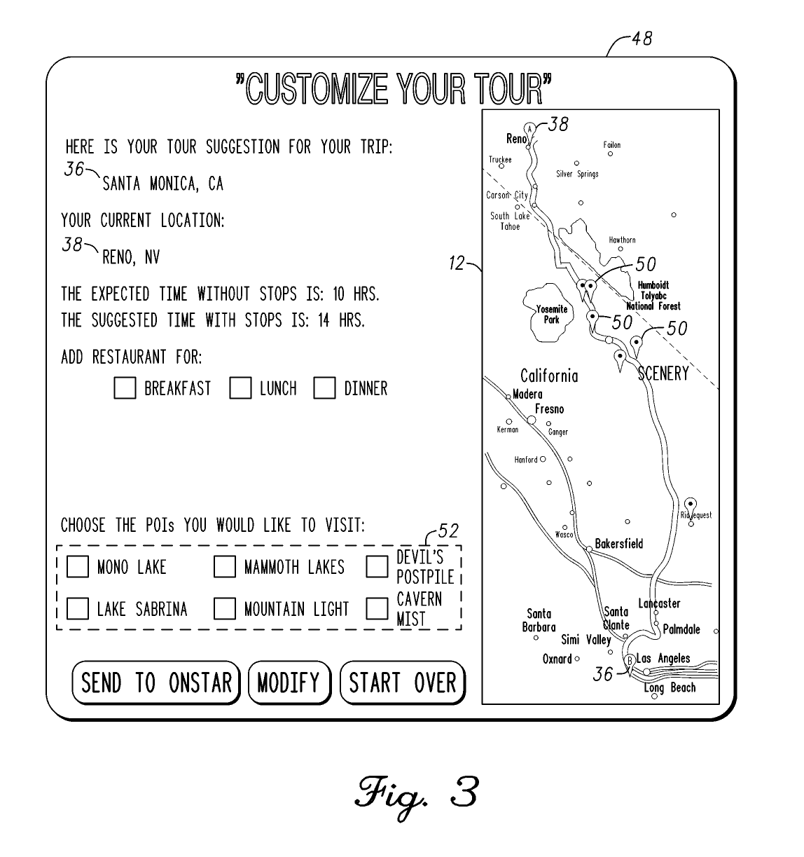

FIG. 3 illustrates an exemplary Internet web page 48 that may be displayed on computer 20 and that is designed to permit a user to edit a tour produced by system 10 of FIG. 1. In this exemplary embodiment, and with continuing reference to FIG. 1, tour 12 begins at a starting address 38 in Reno, Nev., and terminates at an ending address 36 in Santa Monica, Calif. Tour 12 is presented in the form of a map that identifies each POI with a respective icon or maker 50. In other embodiments, tour 12 may comprise a listing of POIs without a map.

Web page 48 also presents a list 52 of POIs that correspond with markers 50 and the user is asked to identify which of the presented POIs that the user would like to visit. In some embodiments, web page 48 may also present a list of predefined tours that the user could select and integrate into their final tour. Each POI included in list 52 includes a selectable link. Each selectable link may lead to a separate website associated with that POI or to additional information about the POI stored on data storage device 16. By selecting the link, the user is enabled to make an informed decision regarding whether to include that POI in tour 12.

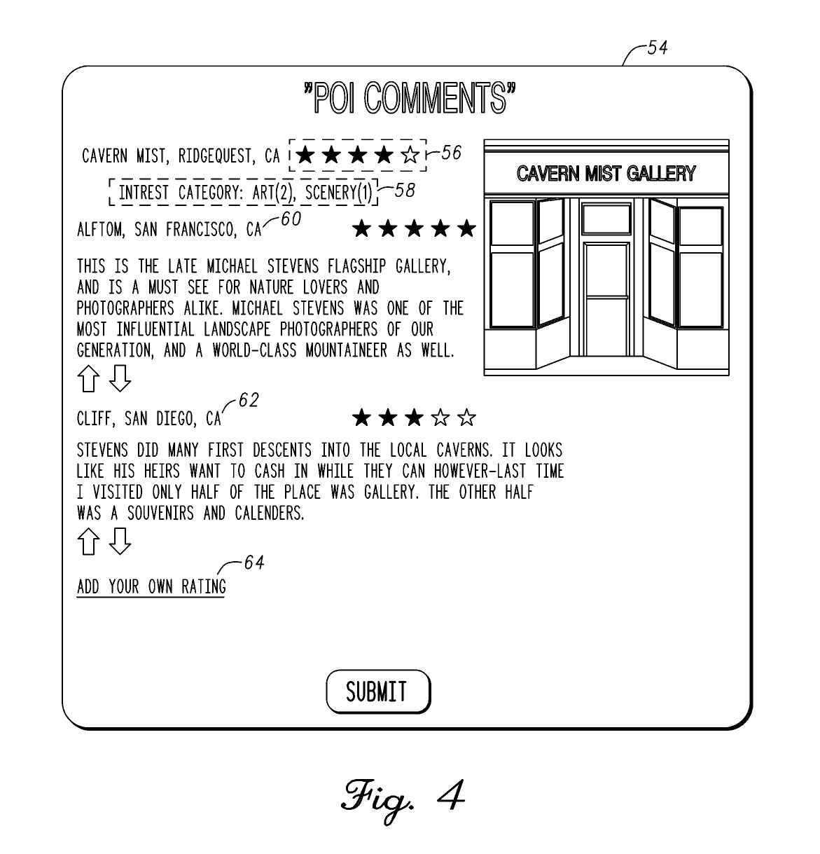

FIG. 4 illustrates an exemplary Internet web page 54 that may be displayed on computer 20 and that provides a user with information about one of the POIs included in the tour produced by system 10 of FIG. 1. In this exemplary embodiment, and with continuing reference to FIG. 1, information about Cavern Mist in Ridgequest, Calif. is presented. One item of information presented is an overall rating 56 of four stars out of a possible five stars. This rating is provided by contributing users who have visited this POI.

Located below the name and the rating of the POI is an identification of interest categories 58 that Cavern Mist falls within. Accordingly, a user interested in art and scenery may enjoy this POI.

Positioned below interest categories 58 are two user reviews, first user review 60 and second user review 62. These user reviews were provided by contributing users who have each visited this particular POI and who subsequently visited website 18 to provide comments. In the illustrated embodiment, first and second user reviews 60 and 62 include a narrative and an individual rating supplied by each contributing user. If the user composing tour 12 chooses to include Cavern Mist on their tour, then when their vehicle approaches Cavern Mist, portable device 34 will trigger a playback of audio commentary and possibly video footage as well, depending upon the equipment available to the portable device. In some embodiments, the playback may optionally include some or all of the user reviews, although it is anticipated that such user reviews will primarily be used to aid the user in selecting which POIs to include in the tour. This can be accomplished through the use of a text to speech engine embedded in the user's vehicle or in portable device 34. In circumstances where there are numerous reviews supplied by contributing users, a user composing a tour may identify and select which of the user reviews are to be included in tour 12 and played back to the user during the tour. If there's enough crowd-sourced content at a particular POI and the user is providing scoring (e.g. five stars) for each review, it may be preferable to have the mobile device trigger call to server 14 to play the content and solicit reviews. However, if there's only a relatively small amount of content, it may be preferable to simply include the content as part of tour 12.

In other embodiments, the contributing user can upload audio commentary and video footage to website 18 for review by the user at the website and for playback to the user during the tour.

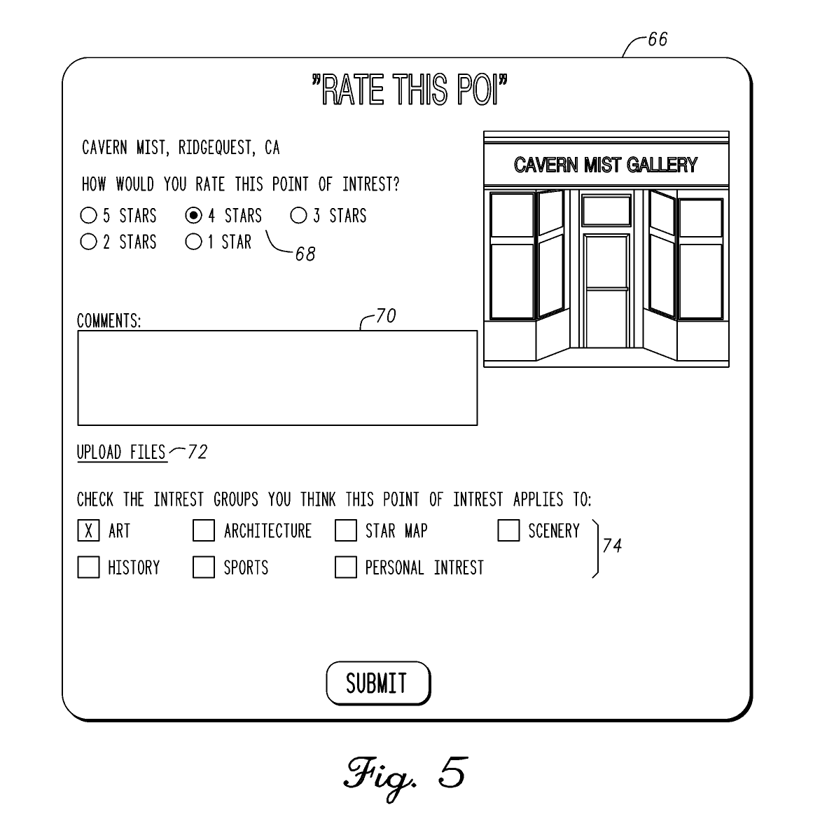

Beneath first and second user reviews 60 and 62, a rating link 64 is provided which allows a contributing user to add their own rating and review of the Cavern Mist POI. If a contributing user selects rating link 64, then website 18 will divert the contributing user to the web page illustrated in FIG. 5.

FIG. 5 illustrates an exemplary Internet web page 66 designed to permit a contributing user to provide feedback regarding a POI. With continuing reference to FIGS. 1 and 4, a contributing user selecting rating link 64 will be diverted to web page 66. At this web page, a contributing user can rate the POI by selecting a rating that corresponds with their assessment from a menu 68 of ratings. Located below menu 68 is a dialogue box 70 where the contributing user can add commentary relating to their experience at Cavern Mist.

Located below dialogue box 70 is an upload link 72. A contributing user selecting upload link 72 will be presented with a navigation box (not shown) that will permit the contributing user to navigate to a location on a hard drive or other computer peripheral device where photos, audio files, video files, image files, and other data is available. By selecting the appropriate files, the contributing user can upload such data to website 18 where it can then be viewed by other users.

Located below upload link 72 is category menu 74. Here, a contributing user may select one or more categories from a listing of predefined categories that apply to the POI being rated. In some embodiments, this categorization will be used by server 14 in filtering POIs from data storage device 16 for inclusion in subset 26. Note that uploading a POI maybe enabled on a website such as just described, or can be enabled by providing an application on a portable device such as a cell phone that collects the content (text, audio, and pictures) and uploads the content to the website from the device.

In some embodiments, server 14 may offer an Application Program Interface (API) that allows contributing users to automate the upload of information to server 14. This API may be in the form of an HTTP call with POI parameters. Such an API is useful for easily uploading a large number of POIs and pre-packaged tours that already exist on another server owned by the contributing user. Likewise, the API may also allow third-party applications to provide a new user interface into the tour generating features of this invention. Design and implementation of such APIs are commonly understood in the industry.

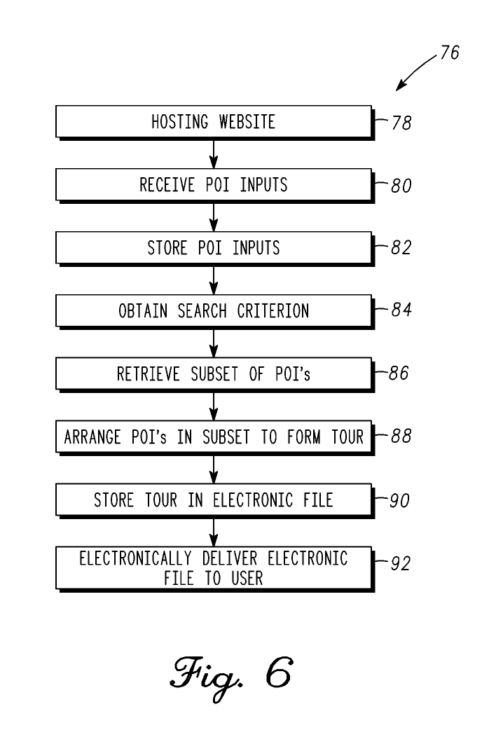

FIG. 6 is a flow diagram illustrating the steps of a method 76 for producing a tour. At block 78, a server is used to host an Internet accessible website. At block 80, the server receives POI inputs from contributing users accessing the Internet accessible website. At block 82, the POI inputs are stored for future use in a data storage device that is operatively coupled to the server.

At block 84, one or more POI search criterion are obtained from a user visiting the Internet website hosted on the server. The POI criterion may be supplied by a user accessing the Internet accessible website for the purpose of composing a tour. At block 86, the server retrieves a subset of POI inputs and/or routes that correspond with the search criterion supplied by the user. At block 88, the server arranges the POI inputs and/or routes in the subset to form a tour.

At block 90, the server stores the tour in an electronic file. In some embodiments, such storage will be temporary. At block 92, the electronic file is electronically delivered to the user composing the tour. In some embodiments, the file will first be converted to a generic file format to facilitate use of the electronic file with a wide variety of portable devices. In other embodiments, the user may be presented with an option to select which of several file formats the electronic file may be downloaded in or converted to. Once the user has the electronic file, the user can download the tour to a portable device and then access the electronic file when the user takes the tour. In other embodiments, the user can download the electronic file directly to a portable device.

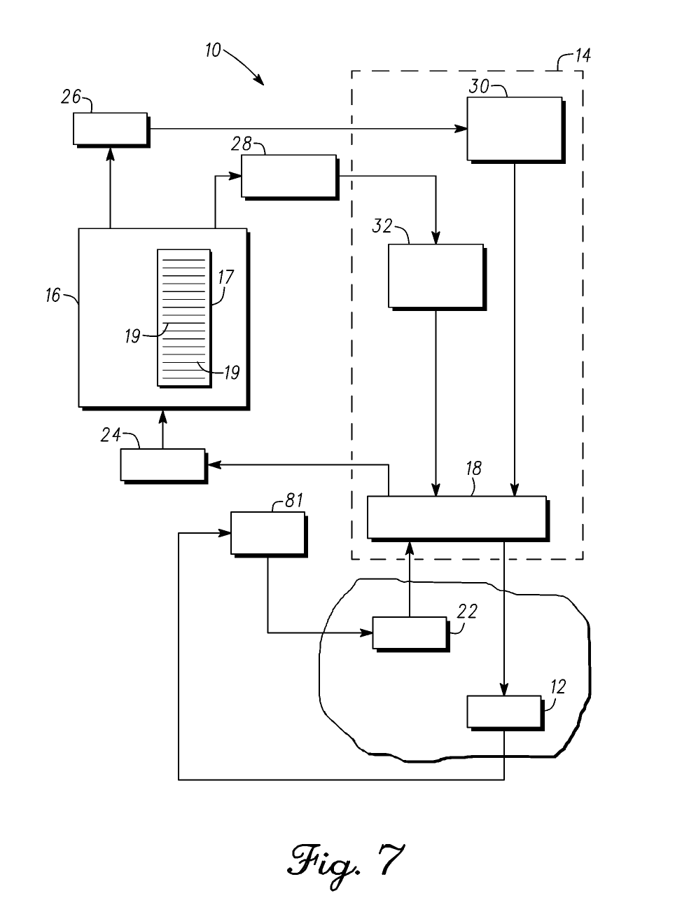

FIG. 7 is a schematic view illustrating an alternate way to access the system of FIG. 1 to produce tour 12. As illustrated in FIG. 7, a user may access website 18 using mobile device 81. Mobile device 81 may be any type of portable device or embedded navigation system that is Internet enabled. Such devices include, but are not limited to, a smart phone, a personal digital assistant, an aftermarket navigation system, a tablet device, and the like.

The user may use mobile device 81 to provide input 22 into website 18 in substantially the same manner as described above with respect to computer 20 of FIG. 1. Similarly, the user may receive first electronic file 30 and/or second electronic file 32 containing tour 12 using mobile device 81. Accessing website 18 using mobile device 81 gives the user the flexibility to create tour 12 from a location, and at a time of the user's choosing. The user may even do so from a vehicle while driving, and in this manner, can create and take driving tours on the fly. Such an arrangement affords the user great flexibility and the capability to turn any road trip or driving excursion into a guided tour.

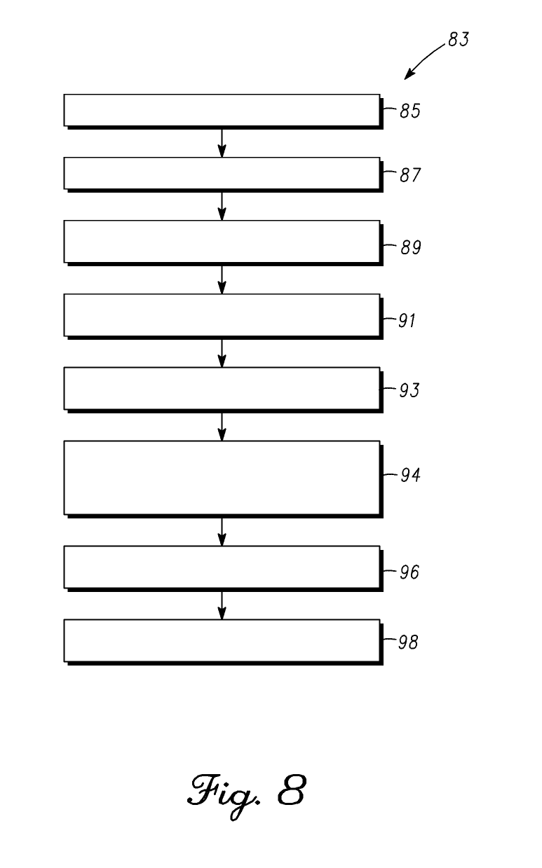

FIG. 8 is a flow diagram illustrating an example of a method 83 for creating and taking a driving tour using information derived from crowd sourcing. With continuing reference to FIGS. 1-8, at block 85, a user accesses an Internet website such as, but not limited to website 18, that is associated with a system that is configured to compose a driving tour using user inputs and crowd sourced information such as, but not limited to, system 10. The user may access the website from any location of the user's choosing including, but not limited to the user's vehicle. The user may do so using an Internet enabled mobile device such as portable device 34 or an Internet enabled navigation system that is embedded into the vehicle.

At block 87, the user inputs one or more criterion into the website that is relevant to the creation of a tour. For instance, the user may identify a start date, an end date, and/or a total amount of time that the user is willing/able to dedicate to the driving tour. The user may input one or more destinations and/or a point of embarkation for the driving tour. The user may also identify a theme for the driving tour. For example, the user may specify a preference to visit sights of historical significance, sights of natural beauty, sights having a sports theme, sights having a child-friendly theme, and the like. In some embodiments, the user may also input one or more features/circumstances that should be avoided when the driving tour is composed. For example, the user may wish to avoid bridges, all tolls or tolls above a predetermined cost. The user may also wish to avoid content that may be inappropriate for children and sources of discomfort such as, but not limited to, sensitivity to hot or cold climates, height concerns (e.g. if the user has vertigo), and aggravating environmental conditions such as pollen or pollutants (e.g. if the user has allergies).

At block 89, the user creates the driving tour using the website. This step may include, but is not limited to, reviewing the criterion input by the user, confirming its accuracy, paying any requisite fee, and submitting the data to the website for generation of the driving tour. The website may then execute one or more algorithms as discussed above and then present to the user a list of one or more POIs. The user may review the list of POIs, select those that are of interest to the user, deselect those that are not of interest to the user, and thereafter finalize the list of POIs to form the driving tour. The website may save the driving tour in an electronic file which may be downloaded to a computer or mobile device of the user's choosing.

The electronic file may contain a variety of information about each POI in the driving tour as well as navigation instructions to, and between, the various POIs. Such information may include, but may not be limited to the street address, the GPS coordinates, the name, and the category of each POI. The electronic file may also include multi-media information for each POI including a description/synopsis of each POI, user ratings, one or more images, audio commentary, and video footage relating to each POI in the driving tour.

At block 91, the user obtains the electronic file containing the driving tour. The electronic file may be transmitted to the computer or mobile device with which the user accessed the website, or to another computer or mobile device as designated by the user. At this step, or during the previous step, the user may designate a preferred format for the electronic file. This permits the user to select a format that will be compatible with the user's mobile device i.e., a format which the mobile device will be capable of loading and executing.

At block 93, the user loads the electronic file into a mobile device. For example, if the user accessed the website using a desktop computer and downloaded the electronic file to that desktop computer, then at this step, the user may transfer the electronic file to a mobile device that the user intends to use on the tour. In other examples, at this step, the user may transfer the electronic file from one mobile device to one or more other devices. In examples where the user has accessed the website using the same mobile device that the user intends to use to take the tour, and wherein the electronic file has been downloaded directly to that mobile device, this step may simply comprise accessing or otherwise running the electronic file using the mobile device.

At block 94, the user utilizes the mobile device and the electronic file to take the driving tour. Using the mobile device, the user may select the electronic file from a list of electronic files that are saved or stored on the user's mobile device, and may instruct the mobile device to run a program that utilizes the electronic file. Once executed, the mobile device will provide the user with navigation guidance that enables the user to take the driving tour.

In some examples, the user may operate the mobile device as a stand alone device that simply broadcasts aloud a series of navigation instructions that will enable the user to drive to each POI. In other examples, the user may connect the mobile device to an onboard vehicle system, such as a stereo or navigation system, through which the mobile device may broadcast the navigation instructions.

In instances where the mobile device has GPS or other location detection capabilities, the navigation guidance may comprise real-time guidance based on the vehicle's location. In other examples where the mobile device lacks any sort of location detection capabilities, the mobile device may simply playback the navigation instructions to the driver who may alternatively pause and play the mobile device in a manner that is synchronized with the location of the vehicle.

When the user has loaded the tour onto a mobile device that has location detection capability, the electronic file may include geographically synchronized commands (also known as geobounds or geoboxes) that will trigger the mobile device to playback information about an upcoming POI when the vehicle approaches to within a predetermined distance from the POI. The information that is played back may include audio commentary and/or images and/or video footage. When the user has loaded the tour onto a mobile device that lacks any sort of location detection capability, then the electronic file, the mobile device, and an onboard navigation system may cooperate to provide information about a POI as the vehicle approaches the POI, as discussed in greater detail below.

In some examples of method 83, the method may further include the step of modifying the driving tour during the driving tour, as indicated at block 96. If for any reason the user wishes to modify the driving tour, the user may do so from the vehicle during the tour by accessing the website as discussed above with respect to block 85. When doing so, the user may access the electronic file containing the driving tour, make any desired modifications, and then download the modified tour to the mobile device. In other examples, such modification of the tour may be accomplished by accessing the electronic file loaded into the mobile device using the mobile device itself. In this manner, the user can add additional POIs to the driving tour, delete POIs from the driving tour, or rearrange the sequence for visiting the POIs of the driving tour.

In some examples of method 83, the user may provide feedback to the website regarding the POIs visited by the user as indicated at block 98. The user may provide such feedback using the mobile device and may do so during the driving tour. For example, the user may use the mobile device to rate a POI while the user is visiting the POI. In other examples, the user may upload an electronic file to the website using the mobile device. Such an electronic file may include audio commentary, images, and/or video footage recorded at the POI. Once uploaded to the website, such feedback can be made immediately available to other users of the website.

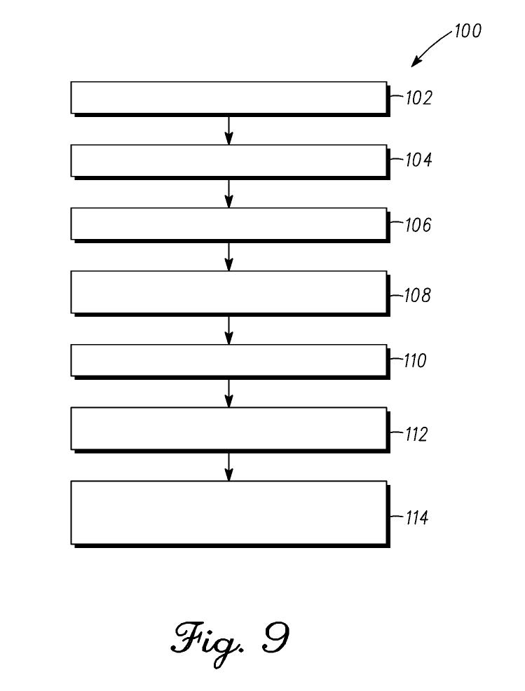

FIG. 9 is a flow diagram illustrating another example of a method 100 for creating and taking a driving tour using information derived from crowd sourcing. With continued reference to FIGS. 1-9, blocks 102, 104, 106, 108, and 110 are identical to blocks 85, 87, 89, 91, and 93, respectively of method 83, shown in FIG. 8. Accordingly, the discussion that pertains to those corresponding blocks of FIG. 8 is incorporated here by reference and will not be repeated.

At block 112, the mobile device, which, in this example, may lack any location detection capability of its own, is connected to a navigation system that is associated with the vehicle. The navigation system may be an aftermarket navigation system that is removably mounted to the vehicle or it may be an embedded navigation system that is permanently mounted to the vehicle. The connection between the mobile device and the navigation system may be via either a wired or wireless connection. Across this connection the mobile device may be configured to provide information to the navigation system and vice versa. Such information may include, but is not limited to, information included in the electronic file and information relating to the current location of the vehicle.

At block 114, the user utilizes the mobile device, the electronic file and the navigation system associated with the vehicle to take the driving tour. The mobile device may be configured to play back navigation guidance, either through loudspeakers inherent to the mobile device itself, through another onboard vehicle system (i.e., the vehicle's stereo) or through the vehicle's navigation system. The mobile device and the navigation system associated with the vehicle are configured to cooperate to keep track of the vehicle's location and to provide navigation guidance to the user that is synchronized with the vehicle's location. For example, the mobile device and the navigation system may cooperate to provide a set of driving instructions to the user that pertains only to a next waypoint, and to wait until the user has reached the next waypoint before providing navigation instructions needed to get to the next waypoint.

In an embodiment, the mobile device may be configured to control the navigation system associated with the vehicle, to provide the navigation system with location information for each POI, and to use the navigation system to guide the user from POI to POI. In other examples, the mobile device may be configured to receive location information from the navigation system and, in that manner, use the navigation system associated with the vehicle in lieu of an internal location detection device to provide navigation guidance and to trigger the playback of information pertaining to POIs.

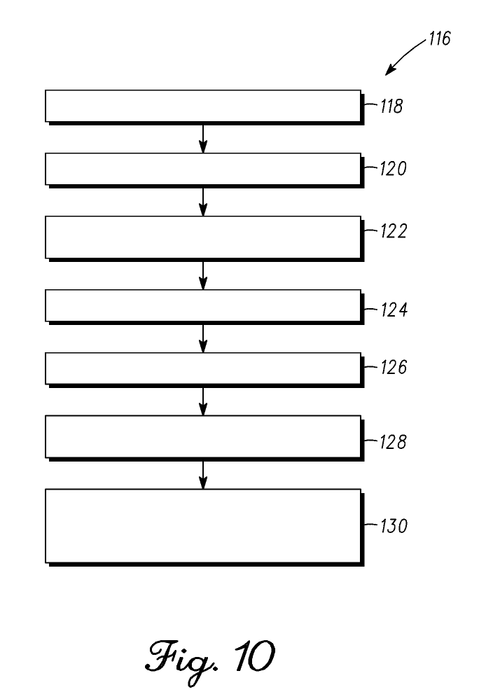

FIG. 10 is a flow diagram illustrating still another example of a method 116 for creating and taking tour 12 using information derived from crowd sourcing. With continued reference to FIGS. 1-10, blocks 118, 120, 122, 124, 126, and 128 are identical to blocks 85, 87, 89, 91, 93, and 94 respectively of method 83, shown in FIG. 8. Accordingly, the corresponding discussion is incorporated here by reference and will not be repeated.

At block 130, the user receives information about a POI on the driving tour in a manner that is synchronized with the user's location. For instance, when the user arrives at a POI on the tour, the mobile device, either through the use of its own internal location determination capability or through cooperation with a navigation system associated with the vehicle, may be configured to trigger playback of information pertaining to the POI. Such information may include a prerecorded narrative about the POI, images, video footage, commentary recorded by previous visitors to the POI, any other information pertaining to the POI, and any combination thereof. Accordingly, upon arrival at a POI, a user may be presented with a multimedia presentation that highlights the attributes of the POI to the user. In some embodiments, this playback of information may be triggered automatically when the vehicle approaches to within a predetermined distance from the POI or at a predetermined period of time in advance of anticipated arrival at the POI.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

What is claimed is:

1. A method for creating and taking a driving tour, the method comprising the steps of:
accessing an Internet website configured to enable a user to compose a driving tour based in part on the information derived from crowd sourcing and in part on a user-specified criterion;
inputting the user-specified criterion into the Internet website;
creating the driving tour using the Internet website, the driving tour having a point of interest;
obtaining an electronic file from the Internet website containing the driving tour;
loading the electronic file into a mobile device; and
utilizing the mobile device and the electronic file to take the driving tour.

2. The method of claim 1, wherein the accessing step comprises accessing the Internet website using the mobile device.

3. The method of claim 2, wherein the accessing step further comprises accessing the Internet website from a vehicle.

4. The method of claim 3, further comprising the step of modifying the driving tour during the driving tour from the vehicle.

5. The method of claim 4, wherein the modifying step comprises one of adding an additional point of interest to the driving tour, deleting an undesired point of interest from the driving tour, or rearranging a sequence for traveling to the point of interest.

6. The method of claim 1, wherein the inputting step comprises identifying a destination.

7. The method of claim 1, wherein the inputting step comprises identifying a point of embarkation.

8. The method of claim 1, wherein the inputting step comprises identifying an amount of time available for the driving tour.

9. The method of claim 1, wherein the inputting step comprises identifying a theme for the driving tour.

10. The method of claim 1, wherein the utilizing step comprises connecting the mobile device to a vehicle system and wherein the method further comprises the step of receiving navigation guidance from the mobile device via the vehicle system.

11. The method of claim 1, further comprising the step of providing feedback to the Internet website during the driving tour regarding the point of interest.

12. The method of claim 11, wherein the providing step comprises rating the point of interest

13. The method of claim 11, wherein the providing step comprises uploading a second electronic file to the Internet website, the second electronic file containing information about the point of interest.

14. A method for creating and taking a driving tour, the method comprising the steps of:
accessing an Internet website configured to enable a user to compose a driving tour based in part on the information derived from crowd sourcing and in part on a user-specified criterion;
inputting the user-specified criterion into the Internet website;
creating the driving tour using the Internet website, the driving tour having a point of interest;
obtaining an electronic file from the Internet website containing the driving tour;
loading the electronic file into a mobile device;
connecting the mobile device to a navigation system associated with a vehicle; and
utilizing the mobile device, the electronic file, and the navigation system to take the driving tour.

15. The method of claim 14, wherein the utilizing step comprises receiving navigation guidance from the navigation system that directs the user to the point of interest on the driving tour.

16. The method of claim 15, wherein the utilizing step comprises cooperation between the mobile device and the navigation system such that the mobile device communicates the point of interest to the navigation system and wherein the navigation system directs the user to the point of interest.

17. A method for creating and taking a driving tour, the method comprising the steps of:
accessing an Internet website configured to enable a user to compose a driving tour based in part on the information derived from crowd sourcing and in part on a user-specified criterion;
inputting the user-specified criterion into the Internet website;
creating the driving tour using the Internet website, the driving tour having a point of interest;
obtaining an electronic file from the Internet website containing the driving tour;
loading the electronic file into a mobile device;
utilizing the mobile device and the electronic file to take the driving tour; and
receiving information about the point of interest during the driving tour in a geographically synchronized manner.

18. The method of claim 17, wherein the receiving step comprises receiving information about the point of interest upon arrival at the point of interest.

19. The method of claim 17, wherein the receiving step comprises receiving information about the point of interest upon approaching to within a predetermined distance from the point of interest.

20. The method of claim 17, wherein the receiving step comprises receiving a multimedia presentation regarding the point of interest.
